(19) United States
(12) Patent Application Publication
(10) Pub. No.: US 2009/0270078 A1
(43) Pub. Date: Oct. 29, 2009

(54) METHOD FOR CONFIGURATING KEYPAD OF TERMINAL AND THE TERMINAL AND SYSTEM INCLUDING THE TERMINAL AND THE KEYPAD CAPABLE OF RECONFIGURATION

(76) Inventors: Gi-Seon Nam, Seoul (KR); Moon-Kee Kim, Gyeonggi-do (KR); Tae-Ho Yu, Gyeonggi-do (KR); Youg-Ha Jeon, Gyeonggi-do (KR); Ki-Mo Chung, Gyeonggi-do (KR); Jung-Keun Yang, Seoul (KR); Jong-Tae Ihm, Gyeonggi-do (KR); Jung-Yeoun Kim, Gyeonggi-do (KR); Keun-Hwan Choi, Seoul (KR); Byoung-Ki Cho, Seoul (KR)

Correspondence Address: David A. Einhorn, Esq.;Baker & Hostetler LLP, 45 Rockefeller Plaza, New York, NY, 10111, US

(21) Appl. No.: 12/302,671

(22) PCT Filed: May 30, 2007
(86) PCT No.: PCT/KR2007/002625

§ 371 Date: Jun. 22, 2009

(30) Foreign Application Priority Data
May 30, 2006 (KR) 10-2006-0049071
Jul. 20, 2006 (KR) 10-2006-0068010
May 22, 2007 (KR) 10-2007-0049535
May 29, 2007 (KR) 10-2007-0052150

(51) Int. Cl. G06F 3/02; H04M 3/42; H04W 88/02; G06F 15/16

(52) U.S. Cl. 455/414.1; 345/172; 455/566; 709/203

(57) ABSTRACT

Disclosed are a method of configuring a keypad of a terminal, a terminal configured thereby, a system including such a terminal, and a reconfigurable keypad. A keypad server includes keypad configuration files according to various applications implemented in a terminal, and provides the keypad configuration file to the terminal. The terminal receives the keypad configuration file from the keypad server through a wired or wireless network, and includes a keypad area on which a keypad configuration according to the keypad configuration file is displayed. In this way, various types of keypads can be implemented.

### TECHNICAL FIELD

The present invention relates to a method and a system for automatically reconfiguring a keypad according to the use of a terminal, and more particularly to a method of configuring a keypad of a terminal, a terminal configured thereby, a system including such the terminal, and a reconfigurable keypad, in which the keypad of the terminal is reconfigured such that a touch panel reconfigured according to personal taste and convenience is available even when a terminal from the same manufacturer is used, and various character input schemes are supported such that a user can perform an input operation in a desired input scheme irrespective of which manufacturer manufactured the terminal.

### BACKGROUND ART

In recent years, various types of terminals with both telephone and image display functions, such as cellular phones, Internet phones, PDAs, etc., have been widely used. Such terminals go beyond a simple telephone call function, and additionally provide diverse functions and services, such as online/offline games, e-mail, text message service, stock management, schedule management, financial settlement, and the like.

These diverse functions and services provided by the various terminals greatly contribute to the convenience, time management and improved quality of life of users, and are expected to quantitatively and qualitatively advance by applying more diversified and improved services.

Those types of terminals must have a keypad in order to use the diverse functions and services, and the layout and positioning of character input environment setting information, corresponding to the keypad, are preset when the terminals are manufactured.

With regard to this, since a keypad of a conventional terminal is formed such that numerals, English letters or Korean characters are engraved on a narrow keypad, it is impossible for a user to identify key buttons for use in character input or playing a game, or to change the key button layout according to the convenience of the user. Thus, there is a problem in that a user unfamiliar with the preset key button position/size information and character layout corresponding to each key button requires a considerable amount of time to adapt to the layout and positioning of character input environment setting information.

As a solution to this problem of the existing keypad, a mobile communication terminal has recently been launched, which is provided with a touch screen capable of inputting various information through touch sensors implemented on a display panel of the terminal, that is, an LCD. However, the terminal with such a touch screen may reduce the degree of sensory perception due to its inelastic planar structure, and has an additional problem in that its display panel may be easily contaminated with fingerprints, etc.

Further, since each manufacturer of mobile terminals employs a unique character input interface, a user may have difficulty in getting used to a new character input interface when using a mobile terminal, the manufacturer of which is different from that of a previously used terminal.

More specially, since current mobile terminals use different character input schemes according to their manufacturers, a considerable amount of time is required for mastering a new character input scheme so as to get acquainted with the character input scheme of a specific mobile terminal, that is, to freely input characters, symbols, numerals, etc., which imposes a heavy burden on a user.

In general, a touch screen or touch panel is one scheme for the interaction of a user with information and communication equipment employing various displays, and corresponds to an input device that can interface a user with information and communication equipment by directly touching the screen with the user s hand or a pen without any additional peripheral unit. Such a touch screen is largely classified as a capacitive touch screen, a resistive touch screen, a surface acoustic wave (SAW) touch screen, a piezoelectric touch screen, or an infrared touch screen.

According to operational principles, the touch panel is classified as a pressure-sensitive touch panel in which a position is detected on coordinates through sensors responsive to a pressure applied onto a screen surface, or a capacitive touch panel in which sensors are disposed around a screen surface filled with charges (flow of an electric current) and a touch point is discovered by sensing information on lost charges through the sensors.

Particularly, this touch panel has been used as a basic constituent element in a PDA (Personal Digital Assistants), and has recently also been mounted and used in a mobile communication terminal.

That is, the touch panel is provided in order to compensate for the problem that the external size and thickness of a mobile communication terminal increase if separate function buttons are added for performing respective additional services provided through the terminal, so that the thickness of the terminal can be reduced.

However, such a conventional touch panel has a disadvantage in that its use is limited when a user uses specific contents or games because it is uniformly manufactured by the manufacturer of a mobile terminal.

For example, when a game program is run in a mobile terminal, a game player must play the game by using buttons that have specific functions in a touch panel. However, since functions displayed on the touch panel, that is, functions imparted to the touch panel, are different from those used in the game, there is an inconvenience in that the game player must be fully aware of which buttons are to be used in the game.

More specially, if a left movement is assigned to button “4” and a right movement is assigned to button “6” with respect to the right/left movement of an object in a game program, then a game player must recognize the fact that button “4” or button “6” must be selected in order to move an object in the right/left direction.

Moreover, on the part of a game producer, operation functions must be assigned in conformity with the configuration of a commonly used keypad, which imposes restrictions on free production of various types of games.

To overcome these restrictions, a separate joystick has been detachably attached to a mobile terminal, but this has a problem in that a user must separately purchase the joystick, and always carry the joystick with him, so as to attach it to the terminal, if necessary.

### DISCLOSURE OF INVENTION

### Technical Problem

Accordingly, the present invention has been made to solve the above-mentioned problems occurring in the prior art, and the present invention provides a method of configuring a keypad of a terminal, a terminal configured thereby, a system including such a terminal, and a reconfigurable keypad, in which the type, position and size of a character on the keypad can be freely changed according to a user s operation or under the control of terminal software by implementing a flexible display device in the form of a keypad.

Further, the present invention provides a method of configuring a keypad of a terminal, a terminal configured thereby, a system including such a terminal, and a reconfigurable keypad, in which the type, position and size of a character on the keypad can be freely changed according to a user s operation or under the control of terminal software by implementing a touch sensor-mounted display device in the form of a keypad.

Further, the present invention provides a method of configuring a keypad of a terminal, a terminal configured thereby, a system including such a terminal, and a reconfigurable keypad, in which various character input schemes are supported such that a user can perform an input operation in a desired input scheme irrespective of which manufacturer manufactured the terminal.

Further, the present invention provides a method of configuring a keypad of a terminal, a terminal configured thereby, a system including such a terminal, and a reconfigurable keypad, in which a user can perform an input operation in a desired input scheme irrespective of which manufacturer manufactured the terminal by downloading an automata program so as to display touch panels, which are different from a touch panel implemented in the terminal and are manufactured by other manufacturers, on the terminal.

Further, the present invention provides a method of configuring a keypad of a terminal, a terminal configured thereby, a system including such a terminal, and a reconfigurable keypad, in which a user can perform an input operation in a desired input scheme even when the terminal has a common button-type keypad rather than a key panel, so long as the terminal includes an internally stored automata program.

Further, the present invention provides a method of configuring a keypad of a terminal, a terminal configured thereby, a system including such a terminal, and a reconfigurable keypad, in which the keypad of the terminal is reconfigured such that a touch panel reconfigured according to personal taste and convenience is available even when a terminal from the same manufacturer is used.

Further, the present invention provides a method of configuring a keypad of a terminal, a terminal configured thereby, a system including such a terminal, and a reconfigurable keypad, in which a touch panel reconfigured according to the necessity of a user is configured as a package, whether or not the package of the touch panel can be properly implemented in the terminal is authenticated, and then the package is downloaded to the terminal.

Further, the present invention provides a method of configuring a keypad of a terminal, a terminal configured thereby, a system including such a terminal, and a reconfigurable keypad, in which a touch panel is implemented such that it is reconfigured using a keypad server, and can be immediately downloaded and available to the terminal.

### Technical Solution

In accordance with a first aspect of the present invention, there is provided a system for configuring a keypad of a terminal, the system including: a keypad server including keypad configuration files according to various applications to be implemented in the terminal, and providing the terminal with the keypad configuration files; and the terminal receiving the keypad configuration files from the keypad server through a wired or wireless network, and including a keypad area on which keypad configurations according to the keypad configuration files are displayed.

In accordance with a second aspect of the present invention, there is provided a system for implementing various types of touch panels, the system including: a keypad server creating a keypad configuration file, to be displayed on a touch panel of a mobile terminal, by reconfiguring at least one of a shortcut button, a key button shape and a key button layout; and the mobile terminal using the keypad configuration file as the touch panel by downloading the keypad configuration file from the keypad server and parsing the downloaded keypad configuration file.

In accordance with a third aspect of the present invention, there is provided a keypad server including keypad configuration files according to various applications to be implemented in a terminal and contents adaptive to respective keypad configurations according to the keypad configuration files, and providing the terminal with the keypad configuration files and the contents through a wired or wireless network.

In accordance with a fourth aspect of the present invention, there is provided a mobile terminal supporting various character input schemes, the mobile terminal including: a keypad implemented in such a manner as to display a second keypad different from a first keypad provided in the terminal and enable touch input through the second keypad; a conversion unit converting a key event in such a manner as to coincide with an input scheme corresponding to the second keypad; and an output unit outputting character data corresponding to the converted key event.

In accordance with a fifth aspect of the present invention, there is provided a mobile terminal having various types of touch panels, the mobile terminal including: a manager module dividing a package to be implemented in a touch panel of the terminal into a markup language and a resource, and managing respective data thereof; a parser module parsing the touch panel based on the markup language and the resource; a renderer displaying data for the finally parsed touch panel on a screen; and a control module recognizing a pressed signal input through the touch panel as a key event signal.

In accordance with a sixth aspect of the present invention, there is provided a keypad for inputting desired information into a terminal through key button input, the keypad including: a display unit displaying a keypad configuration having a given key button layout provided by the terminal; and a key button input recognition circuit located on a front or rear surface of the display unit, and recognizing a pressure transferred when a given key button area of the keypad configuration displayed on the display unit is selected.

In accordance with a seventh aspect of the present invention, there is provided a keypad for inputting desired information into a terminal through key button input, the keypad including: a display unit displaying a keypad configuration having a given key button layout provided by the terminal; and a transparent touch sensor array located on a front surface of the display unit, recognizing a touch of a user when a given key button area of the keypad configuration displayed on the display unit is selected, and transferring an electrical signal according to the touch of the user to an internal logic of the terminal.

In accordance with an eighth aspect of the present invention, there is provided a method of configuring a keypad of a terminal, the method including the steps of: a) receiving and storing at least one of various keypad configuration files, each of which corresponds to an application, from a keypad server to the terminal through a wired or wireless network; b) selecting a specific keypad configuration file having a given keypad configuration from among the stored keypad configuration files by the terminal; c) executing the selected keypad configuration file through the application by the terminal; and d) displaying the keypad configuration according to the specific keypad configuration file on a keypad area of the terminal.

In accordance with a ninth aspect of the present invention, there is provided a method of configuring a keypad of a terminal, the method including the steps of: a) selecting a specific keypad configuration file having a given keypad configuration from among already stored keypad configuration files by the terminal; b) executing the selected keypad configuration file through an application by the terminal; and c) displaying the keypad configuration according to the specific keypad configuration file on a keypad area of the terminal.

In accordance with a tenth aspect of the present invention, there is provided a method of inputting a character in a mobile terminal, the method including the steps of: a) displaying a second keypad different from a first keypad provided in the mobile terminal; b) performing touch input by using the second keypad; c) converting a key event generated by the touch input in such a manner as to coincide with an input scheme corresponding to the second keypad; and d) outputting character data corresponding to the converted key event.

In accordance with an eleventh aspect of the present invention, there is provided a method of inputting a character in a mobile terminal, the method including the steps of: □) installing an automata program for driving a second keypad having a different input system from that of a first keypad provided in the mobile terminal; □) driving the automata program by using a menu item of the mobile terminal to thereby display an image of the second keypad in the mobile terminal; □) if a key button corresponding to the second keypad is selected in the first keypad, converting a key event generated by the key button of the first keypad in such a manner as to coincide with an input scheme corresponding to the second keypad; and □) outputting character data corresponding to the converted key event.

In accordance with a twelfth aspect of the present invention, there is provided a method of implementing various types of touch panels in a mobile terminal, the method including the steps of: a) reconfiguring at least one of a shortcut button, a key button shape and a key button layout of a touch panel to be implemented in the mobile terminal; b) uploading the touch panel, and performing authentication for applicability of the touch panel; c) upon completing the authentication of the touch panel, downloading the touch panel to the mobile terminal; and d) using the touch panel in the mobile terminal.

In accordance with a thirteenth aspect of the present invention, there is provided a method of implementing various types of touch panels in a mobile terminal, the method including the steps of: □) creating a touch panel to be implemented in the mobile terminal as a package; and □) downloading the package of the touch panel to the mobile terminal.

### ADVANTAGEOUS EFFECTS

As noted from the forgoing, the present invention can provide a user interface that enables a user to freely change the type, position and size of a character on a keypad according to the user s operation or under the control of terminal software by implementing a flexible display device in the form of a keypad.

Further, when the present invention is applied, additional services can be created, for example, contents, such as games coupled with keypad configurations that have been implemented in various terminals having given information input means, can be provided.

Moreover, when the present invention is applied, the problem that a user unfamiliar with a character layout requires a considerable time to adapt to the layout and size of character input environment information can be solved, and thus when a terminal is replaced by a new one, an inconvenience caused by a difference between both the terminals can also be solved. At the same time, it is easy for a terminal manufacturer to engrave the name of a specific key performing various functions.

Further, according to the present invention, a user can input characters, symbols, numerals, etc. by using a desired input scheme, and consequently can reduce time expenditure and stress caused by mastering a new input scheme.

Additionally, by enabling a user to use a familiar input scheme irrespective of which keypad is provided in a mobile terminal, the user need not invest time and effort when using another person s mobile terminal, for example, need not receive help from someone or make reference to a manual in order to input characters, numerals etc. in a different input scheme of another person s mobile terminal.

Further, according to the present invention, there is an advantage in that a user can personally manufacture a touch panel according to his/her taste and necessity, and a manufacturer of software to be driven in a mobile terminal can diversely expand services for the mobile terminal because he/she can manufacture a touch panel compatible with his/her software and distribute it together with the software.

Finally, since it is possible to parse an event input by a touch panel, based on a markup language and a resource linked with each other, there is an advantage in that a touch panel consisting only of specific keys can be created or a functional change to a specific touch panel for a specific interface can be made.

### BRIEF DESCRIPTION OF THE DRAWINGS

The accompanying drawings are only for the purpose of illustrating preferred embodiments of the present invention, and promote the understanding of the present invention in connection with the following detailed description. Therefore, the present invention should not be construed as being limited to the illustrations in the accompanying drawings.

The above and other objects, features and advantages of the present invention will become more apparent from the following detailed description taken in conjunction with the accompanying drawings, in which:

FIG. 1 is a block diagram schematically illustrating the structure of a system for configuring a keypad of a terminal according to a preferred embodiment of the present invention;

FIG. 2 is a block diagram schematically illustrating the structure of a terminal according to a preferred embodiment of the present invention;

FIG. 3 is a side sectional view schematically illustrating the structure of a keypad according to a preferred embodiment of the present invention;

FIGS. 4 to 6 are side sectional views schematically illustrating the structures of keypads according to preferred embodiments of the present invention;

FIG. 7 is a side sectional view schematically illustrating the structure of a keypad according to another preferred embodiment of the present invention;

FIGS. 8 to 13 are views illustrating a keypad according to the present invention, which is applied to numeral/character input keys of a folder type mobile terminal;

FIGS. 14 and 15 are views illustrating a keypad according to the present invention, which is applied to function keys of a slide type mobile terminal;

FIGS. 16 to 18 are views illustrating a keypad according to the present invention, which is applied to a terminal for exclusive use in music and moving picture reproduction;

FIG. 19 is a flowchart explaining a method of configuring a keypad of a terminal according to a preferred embodiment of the present invention;

FIG. 20 is a flowchart explaining a method of using a mobile terminal supporting various character input schemes according to a preferred embodiment of the present invention;

FIG. 21 is a flowchart explaining a method of using a mobile terminal supporting various character input schemes according to another preferred embodiment of the present invention;

FIG. 22 is a flowchart explaining a method of implementing various types of touch panels in a mobile terminal according to a preferred embodiment of the present invention; and

FIG. 23 is a flowchart explaining a method of implementing various types of touch panels in a mobile terminal according to another preferred embodiment of the present invention.

### BEST MODE FOR CARRYING OUT THE INVENTION

Hereinafter, preferred embodiments of the present invention will be described with reference to the accompanying drawings.

### Embodiment 1

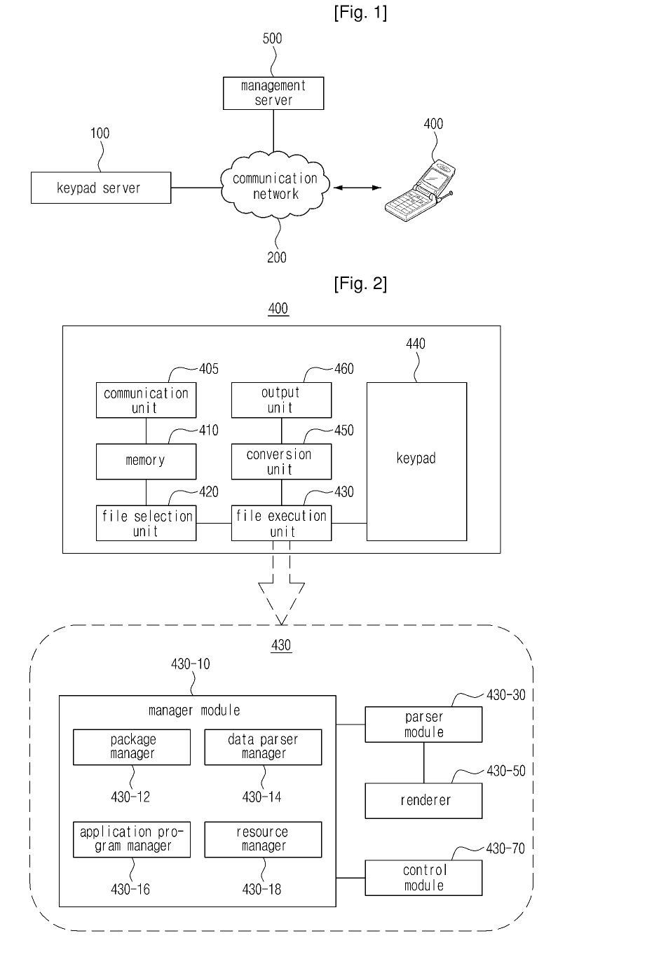

FIG. 1 schematically illustrates the structure of a system for configuring a keypad of a terminal according to a first embodiment of the present invention.

As illustrated in FIG. 1, the system includes a keypad server 100 that creates and stores various keypad configuration files having characters of various countries, special characters, and specific key button layouts applicable to specific games, and provides the stored keypad configuration files; and a terminal 400 that downloads a keypad configuration file provided by the keypad server 100 through a communication network 200 including a wired or wireless network, executes the downloaded keypad configuration file, and displays a keypad configuration reconfigured according to the execution of the keypad configuration file on a keypad area of the terminal.

The keypad server 100 separately may store contents exclusively using the key button layout of a specific keypad configuration file, in addition to the various keypad configuration files, and provide the stored contents to the terminal 400 to which the corresponding keypad configuration files are applied. That is, the keypad server 100 may separately provide a keypad configuration file and contents at the request of the terminal 400. The keypad server 100 may also simultaneously provide a keypad configuration file related to contents when the contents are provided, so that a corresponding keypad configuration can be automatically applied to the provided contents when the contents are executed in the terminal 400.

The terminal 400 refers to not only a mobile terminal, such as a cellular phone, an Internet phone, a PDA phone, etc., but also all kinds of other apparatuses that have certain information input means, such as a keypad, including a PC, a typewriter, a remote control, a PM3P, a PMP, etc. Reference will now be made to FIG. 2 in which the structure of the terminal 400 is illustrated.

The terminal 400 includes a memory 410 for receiving a downloaded keypad configuration file corresponding to an application from the keypad server 100 and storing the received keypad configuration file; a file selection unit 420 for selecting a specific keypad configuration file from among keypad configuration files received from the keypad server 100; a file execution unit 430 for executing a selected keypad configuration file through an application running in the terminal 400; and a keypad 440, located in a common keypad area of the terminal 400, for displaying a keypad configuration reconfigured by executing a keypad configuration file.

The keypad 440 displays various keypad configurations according to keypad configuration file execution by the file execution unit 430, and transfers an electrical signal, which is generated by selecting a button input area set in the displayed keypad configuration, to an internal logic of the terminal 400.

Hereinafter, the structure of the keypad 440 according to the present invention will be described in detail.

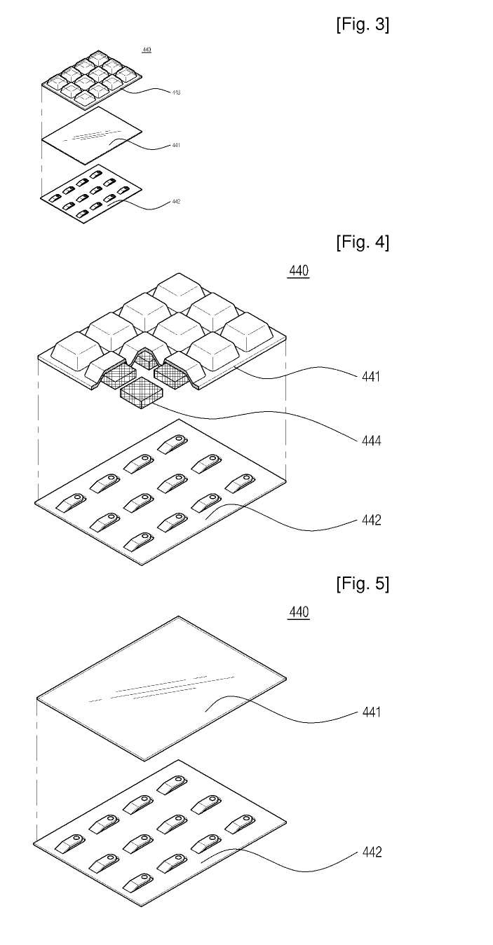

First, a keypad structure will be described with reference to FIG. 3 illustrating a side sectional view of a keypad according to a preferred embodiment of the present invention.

That is, the keypad 440 according to this embodiment includes a display section 441 for receiving a keypad configuration with a given key button layout from the file execution unit 430 of the terminal 400 and displaying the received keypad configuration; a key button input recognition circuit 442, located on the rear surface of the display section 441, for recognizing a pressure transferred when a specific key button area of a keypad configuration displayed on the display section 441 is selected; and a transparent shock-absorbing member 443, located on the front surface of the display section 441, for transferring a pressure generated when a button area is selected and preventing the display section 441 from being damaged by the generated pressure.

A flexible display device, such as an electronic paper or an LCD (Liquid Crystal Display), is used as the display section 441. For reference, when the electronic paper is used, a problem of additional power consumption in applying a keypad does not occur because it is unnecessary to apply power after information recording.

The key button input recognition circuit 442 recognizes a pressure transferred when a specific key button area is selected on the display section 441, and transmits a corresponding electrical signal to an internal logic of the terminal 400.

The shock-absorbing member 443 is formed with protrusions, for example, in the shape of a key button ( [symbol] ), which are positioned corresponding to a key button layout displayed in the display section 441. In this way, problems occurring in the existing touch panel, that is, lowering of the degree of sensory perception and damage of the display section 441, can be solved.

The keypad 440 according to this embodiment, as illustrated in FIG. 3, may be implemented in various ways.

First, as illustrated in FIG. 4, the keypad 440 can replace the existing keypad by forming the display section 441 with protrusions in the shape of a key button and placing the display section 441 over the key button input recognition circuit 442. Here, reference numeral 444 designates an elastic member for supporting the display section 441 and simultaneously making circuit contact with the key button input recognition circuit 442.

Further, as illustrated in FIG. 5, the keypad 440 may be implemented by placing a flat-like display section 441 over a conventional key button input recognition circuit 442.

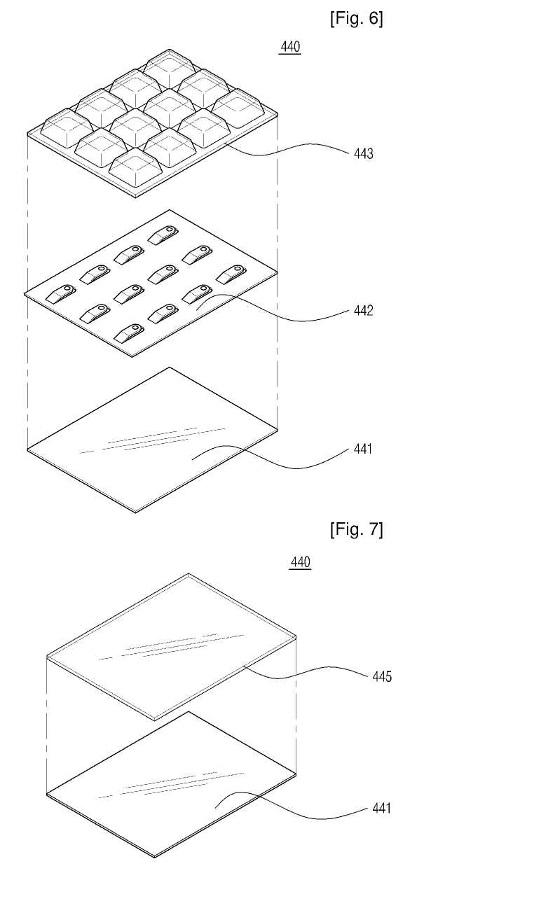

Further, as illustrated in FIG. 6, the keypad 440 may be implemented by sequentially placing the key button input recognition circuit 442 and the shock-absorbing member 443 formed with key button-shaped protrusions ( [symbol] ) over the display section 441.

Next, another keypad structure will be described with reference to FIG. 7 illustrating a side sectional view of a keypad according to another preferred embodiment of the present invention.

That is, the keypad 440 according to this embodiment includes a display section 441 for receiving a keypad configuration with a given key button layout from the file execution unit 430 of the terminal 400 and displaying the received keypad configuration; and a transparent touch sensor array 445, located on the front surface of the display section 441, for recognizing a user s touch when a specific key button area of a keypad configuration displayed on the display section 441 is selected.

A flexible display device, such as an electronic paper or an LCD (Liquid Crystal Display), is used as the display section 441.

The touch sensor array 445 recognizes a user s touch when a specific key button area is selected on the display section 441, and transmits a corresponding electrical signal to an internal logic of the terminal 400. With regard to this, the position of a user touch sensed on the touch sensor array 445 is mapped to the position of a specific key button area on the display section 441 through a software operation.

Reference will now be made to examples of applying a keypad according to the present invention with reference to the accompanying drawings.

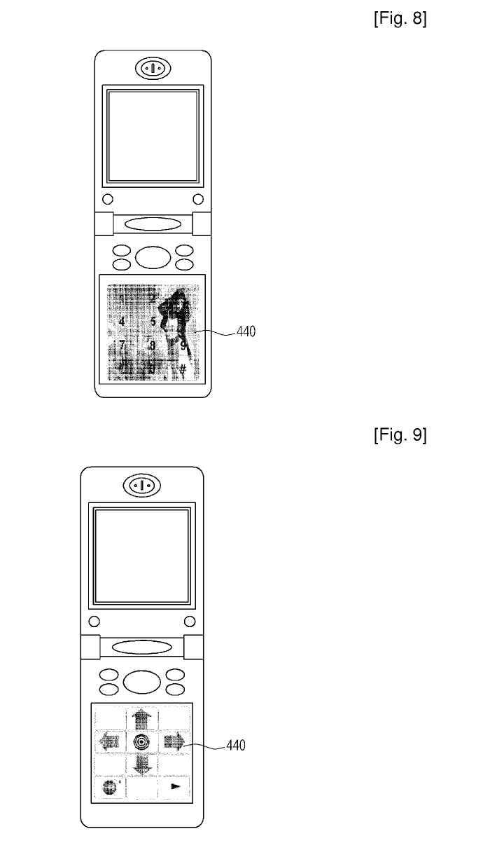

First, referring to FIGS. 8 to 13, a keypad according to the present invention may be applied to numeral/character input keys of a folder type mobile terminal.

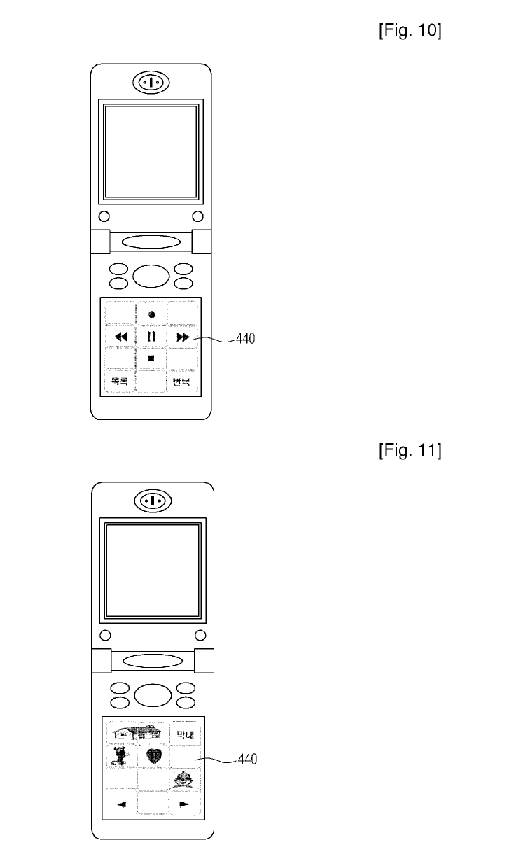

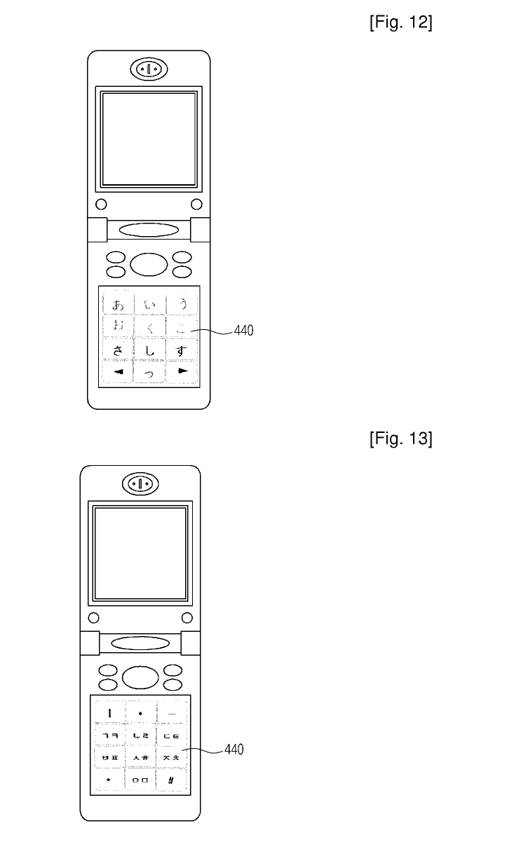

That is, according to a keypad configuration file executed in the file execution unit 430, the keypad 440 applied to a folder type mobile terminal can display a keypad configuration in which the existing key button form is maintained and a specific image is in the background, as illustrated in FIG. 8, and can display a keypad configuration in which a key button layout is changed adaptively to implement a corresponding application when a game, music, a moving picture or the like is reproduced in the terminal, as illustrated in FIGS. 9 and 10. Further, as illustrated in FIG. 11, the keypad 440 can display a keypad configuration that has a key button layout in a shortcut key form using an icon, a character, etc. Moreover, as illustrated in FIGS. 12 and 13, the keypad 440 can display a keypad configuration with a key button layout of new fonts, other country characters, Korean characters, etc.

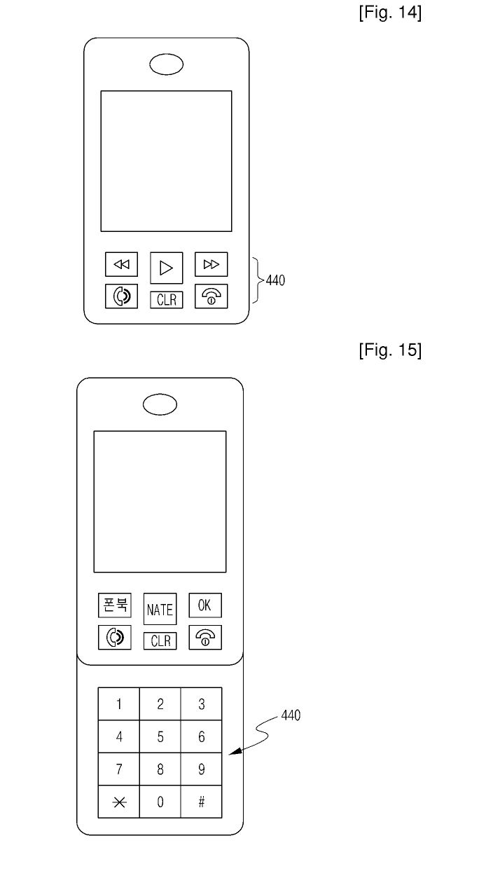

Next, referring to FIGS. 14 and 15, a keypad according to the present invention may be applied to function keys (including a menu key and a selection key) of a slide type mobile terminal.

That is, as illustrated in FIG. 14, the keypad 440 applied to a slide type mobile terminal displays a reproduction button-related key button layout, which is suitable for an operative function of the terminal, for example, music/moving picture reproduction, photographing or video recording, on the function keys when the slide of the terminal is closed. Further, as illustrated in FIG. 15, the keypad 440 displays the existing function keys, such as a menu key, a selection key and a hot key, when the slide is opened.

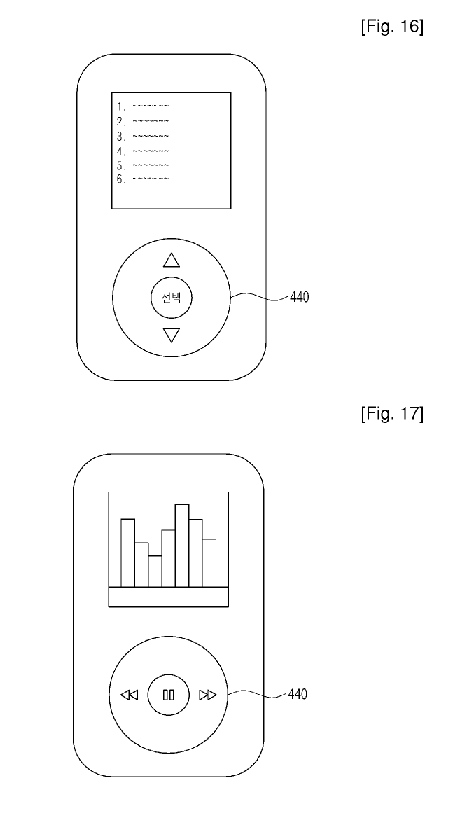

Next, referring to FIGS. 16 to 18, a keypad according to the present invention may be applied to a terminal for exclusive use in music and moving picture reproduction.

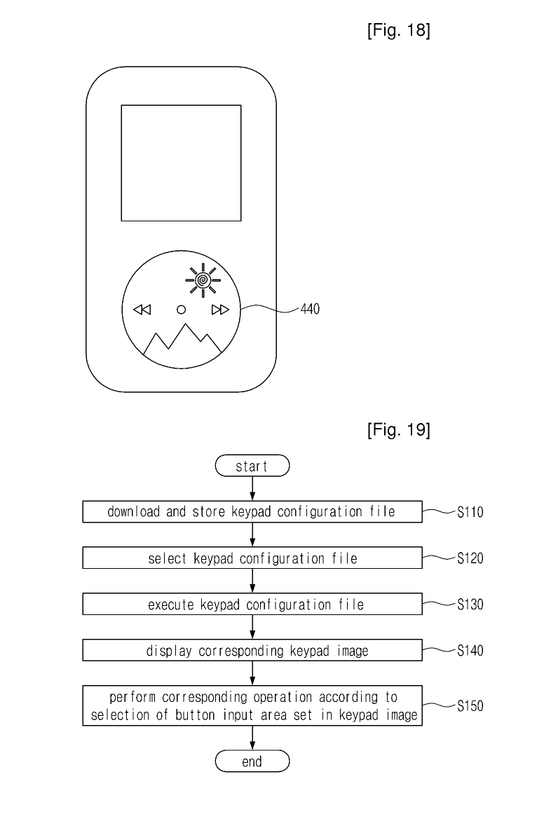

That is, the keypad 440 displays a selection key and direction keys when a file to be reproduced is selected, as illustrated in FIG. 16, and then displays reproduction-related keys upon completing the selection of a file, as illustrated in FIG. 17. Further, as illustrated in FIG. 18, the keypad 440 can display a keypad configuration in which specific keys are displayed, and at the same time a specific image is in the background.

### Embodiment 2

Reference will now be made to a second embodiment of the present invention with reference to a schematic internal block diagram of a terminal supporting various character input schemes, as shown in FIG. 2. The second embodiment will be described on the assumption that the terminal is a mobile terminal.

The mobile terminal 400 includes a keypad 440, a conversion unit 450, an output unit 460, a communication unit 405, and a memory 410.

When the keypad 440 of the mobile terminal 400 is constructed as a touch panel, a first keypad implemented by the manufacturer of the mobile terminal 400 is displayed on the screen of the mobile terminal 400.

If a user wants to use a second keypad that has a different input system from that of the first keypad, the second keypad can be displayed on the screen of the mobile terminal 400 by selecting an item for enabling the use of another keypad from among menu items of the mobile terminal 400.

In one application example, the mobile terminal 400 is provided with a list of keypads according to manufacturers or keypads having different input systems, and if a user selects any one of the keypads in the keypad list, the first keypad currently implemented in the mobile terminal 400 is switched to a different keypad, that is, the second keypad. With regard to this, the mobile terminal 400 is manufactured such that the user can select whether the first keypad is switched to the second keypad permanently or only for a certain period of time.

When the keypad implemented in the mobile terminal 400 is a touch panel, using an automata program capable of implementing the second keypad different from the first keypad provided in the mobile terminal 400, the second keypad is implemented in such a manner as to be displayed in the screen of the mobile terminal 400 and enable touch input.

In another application example, when the keypad of the mobile terminal 400 is not a touch panel but a common button type keypad, an image of the second keypad is displayed on the screen of the mobile terminal 400 by means of the automata program. Thus, the user must actually press key buttons of the first keypad by making reference to the second keypad image displayed in the screen of the mobile terminal 400. With regard to this, the user may memorize keys of the second keypad, corresponding to the respective key buttons of the first keypad, or use stickers that are attached on the key buttons of the first keypad and designate the keys of the second keypad.

Data input through the aforementioned keypad 440 includes at least one of key button input data from the user of the mobile terminal 400, such as KEY_1, KEY_2, . . . KEY_#, the input coordinate of an area selected by the user or input data mapped through the input coordinate in the case of using a touch panel, and input character/symbol data input through all devices used in the mobile terminal 400.

The conversion unit 450 converts a key event generated on the keypad 440 in such a manner as to coincide with an input scheme corresponding to the second keypad. With regard to this, the conversion unit 450 stores a key event generated on the keypad 440 in a queue format, and then reads out and converts the key events one by one.

In one application example, the mobile terminal is further provided with a combination module (not illustrated) for recombining a character completely converted and transferred by the conversion unit 450 with a character converted ahead of the former character and stored in a buffer, that is, a previously combined character, and updating the recombined character to a new combined character in the buffer.

The output unit 460 outputs the character code value of a character to be output for an input of the keypad 440, including an ASCII code or corresponding character code value and all types of code values capable of discerning between characters.

The output unit 460 corresponds to the screen or speaker of the mobile terminal 400, and outputs character data corresponding to the converted key event to thereby enable the user to see or hear a character.

The communication unit 405 has an interface for connecting a separate unit to the mobile terminal 400 so as to download an automata program corresponding to the second keypad, that is, for enabling offline download of the automata program, and/or has a communication module for downloading the automata program by using a wireless data transmission scheme, such as WAP (Wireless Application Protocol), that is, for enabling online download of the automata program.

In the case of the offline download, a separate download unit is not needed when the mobile terminal 400 is provided with a wireless interface unit, such as an infrared communication or Bluetooth interface unit, and a computer for providing an automata program to the mobile terminal 400 is also provided with an infrared communication or Bluetooth interface unit.

In the case of the online download, the mobile terminal 400 downloads a desired automata program through the wireless Internet by accessing a service providing server through the wireless Internet and requesting for downloading the automata program to the mobile terminal 400.

Of course, the mobile terminal 400 may also be provided with the automata program by accessing the service providing server though the wired Internet and requesting downloading of the automata program to the mobile terminal 400.

The memory 410 receives a downloaded automata program for displaying the second keypad through the communication unit 405, and stores the received automata program. The automata program is a program for driving an abstract machine, in which only input/output-related matters are specified while details for the internal structure and operation of the machine are ignored.

The keypad 440 and the output unit 460 of the mobile terminal 400 perform porting so as to coincide with features according to other manufacturers of the terminal 400.

Porting means that an operating program shifts the current operating system environment to a new environment so as to be able to run on another operating system.

### Embodiment 3

Reference will now be made to a third embodiment of the present invention with reference to FIG. 1.

As illustrated in FIG. 1, a system for implementing various types of touch panels includes a mobile terminal 400, a communication network 200, a management server 500, and a keypad server 100.

The mobile terminal 400 includes one LCD or two LCDs. When the mobile terminal 400 includes one LCD, a part of the LCD is formed with a touch panel in which an instruction can be input by touch. Further, when the mobile terminal 400 includes two LCDs, one of them is formed with a touch panel.

In addition, when the mobile terminal 400 includes two LCDs, one of them may be provided with a touch panel function or both of them may be provided with a touch panel function.

With regard to this, the LCD provided with a touch panel function is preferably formed by a touch panel with a soft surface that is depressed and deformed by pressure.

That is, a touch panel that recognizes screen touch if the screen is touched by a stylus pen or a user s finger is classified as a hard type touch panel or a soft type touch panel according to its surface rigidity. In general, a bank ATM machine has a hard type screen.

However, the touch panel of the present invention is preferably implemented as a soft type touch panel. This is because it is preferred to give a user the sense of touch when the user touches the screen of the touch panel with his/her finger.

The keypad server 100 reconfigures at least one of a shortcut button, a key button shape and a key button layout, and displays it on the touch panel of the mobile terminal 400.

Various key button shapes to be implemented in the touch panel are created and stored as a package in the keypad server 100. Thus, if a user selects one of the various key button shapes, a current key button shape is changed to the selected shape. For example, the existing rectangular-, elliptic- or circular-shaped key button may be changed to an image in the shape of a leaf, a bird, a flower, etc., and each key button may be implemented as an animation.

Further, according to software drivable in the mobile terminal 400, a keypad capable of easily driving the software is manufactured as a package in the keypad server 100, or the keypad server 100 has a manufacturing tool that enables a user to manufacture a desired keypad.

The keypad server 100 transmits a keypad configuration file selected or manufactured by a user to the management server 500 and the mobile terminal 400 through the communication network 200, and alternatively transmits the keypad configuration file directly to the mobile terminal by using a certain data cable.

The management server 500 receives a keypad configuration file, which the keypad server 100 creates and transmits, from the keypad server 100, manages the received keypad configuration file, and perform an authentication procedure for checking if the keypad configuration file is manufactured suitable to the specifications of the mobile terminal 400.

If the management server 500 completes the authentication procedure, the keypad configuration file is downloaded from the management server 500 to a requesting mobile terminal 400.

Further, when the keypad configuration file received from the keypad server 100 is not suitable for some specifications of a specific mobile terminal 400, the management server 500 makes reference to the device specifications of a requesting mobile terminal 400, and transmits an advice message to the requesting mobile terminal 400 when it is not recommendable to implement the keypad configuration file in the requesting mobile terminal 400.

FIG. 2 schematically illustrates an internal block diagram of a mobile terminal with various types of touch panels according to a preferred embodiment of the present invention.

In order to apply the present invention to the mobile terminal 400, the mobile terminal 400 has an engine system, an example of which is seen from FIG. 2. The engine system is a module installed in a mobile terminal in which a keypad is formed by a touch panel, and parses a keypad configuration file manufactured by a user or downloaded from the keypad server 100 to thereby display a key button, etc. on the touch panel and generate an event specified in the keypad configuration file.

The mobile terminal 400 includes a manager module 110, a parser module 130, a renderer 150, and a control module 170, and may further include a download module for downloading contents, a keypad configuration file and the like.

The manager module 110 divides a keypad configuration file into a markup language and a resource, and manages respective data thereof. The manager module 110 includes a package manager 112 for managing a downloaded keypad configuration file, a data parsing manager 114 for parsing the markup language and the resource in cooperation with the parsing module 130, a resource manager 118 for storing and managing each key button function of a touch panel, and an application program manager 116. Examples of the markup language include HTML (Hyper Text markup language), SGML (Standardized General Markup language) standardized by ISO (International Organization for Standardization), etc.

The parser module 130 parses the markup language stored in the manager module 110 into meaningful information, based on the resource stored in the resource manager 118, and provides the parsed information to the renderer 150.

The renderer interprets a package of the keypad configuration file parsed by the parser module 130, and displays it on the screen.

Thus, any keypad configuration file manufactured in such a manner as to be represented in the mobile terminal 400 is a link of a markup language with a resource, which is parsed by the engine system and displayed on the touch panel of the mobile terminal 400.

The markup language is defined as an event that prescribes one functional unit (e.g., each button of the touch panel) and its meaning, and the control module 170 recognizes a pressed signal input through the touch panel as an event signal of key input.

Consequently, if a new keypad configuration file is manufactured and downloaded to the mobile terminal, the newly manufactured keypad configuration file is displayed on the touch panel of the mobile terminal, and an event input using the touch panel can be parsed, so that the mobile terminal can diversely expand a range of services.

In one application example, since an event input by the touch panel can be parsed, based on the markup language and the resource linked with each other, it is possible to create a keypad configuration file consisting only of specific keys or design a keypad configuration file in such a manner that a functional change to a specific touch panel for a specific interface can be made.

Reference will now be made to how the present invention as described above operates.

### Embodiment 1

Hereinafter, a method of configuring a keypad of a terminal according to a first embodiment of the present invention will be described in detail.

First, the terminal 400 downloads and stores various keypad configuration files, each of which corresponds to an application, from the keypad server 100 over the communication network 200 (S110). That is, the terminal 400 downloads at least one of keypad configuration files having characters of various countries, special characters, and specific key button layouts applicable to specific games, that is, keypad configurations, from the keypad server 100, and stores the downloaded keypad configuration files in the memory 410. The downloaded keypad configuration files are configured in a menu format so as to facilitate its subsequent selection.

Next, the terminal 400 selects a specific keypad configuration file desired by a user from among the stored keypad configuration files (S120). That is, the terminal 400 selects the corresponding keypad configuration file stored in the memory 410 through the file selection unit 420.

Then, the terminal 400 executes the selected keypad configuration file through an application (S130). That is, the terminal 400 executes the selected keypad configuration file through the file execution unit 430. For reference, it is possible to implement a keypad configuration in which a key button layout of a keypad can be automatically changed according to the scenario of an application running on the file execution unit 430. For example, in the case of writing an SMS message, only Korean characters are displayed instead of English letters or numerals if the Korean language is selected, and only a playback button is displayed when a moving picture is reproduced, so that readability and convenience can be improved.

Thereafter, the terminal transmits a keypad configuration reconfigured according to the execution of the keypad configuration file to the keypad 430, which in turn displays the keypad configuration (S140).

Subsequently, the terminal 400 performs corresponding operations according to the selection of a key button area set in the displayed keypad configuration (S150). In addition, when the terminal 400 resets a keypad configuration file already stored in the memory 410, a desired keypad configuration file can be applied only by selecting a menu item of the menu for downloaded keypad configuration files without accessing the keypad server 100 again.

### Embodiment 2

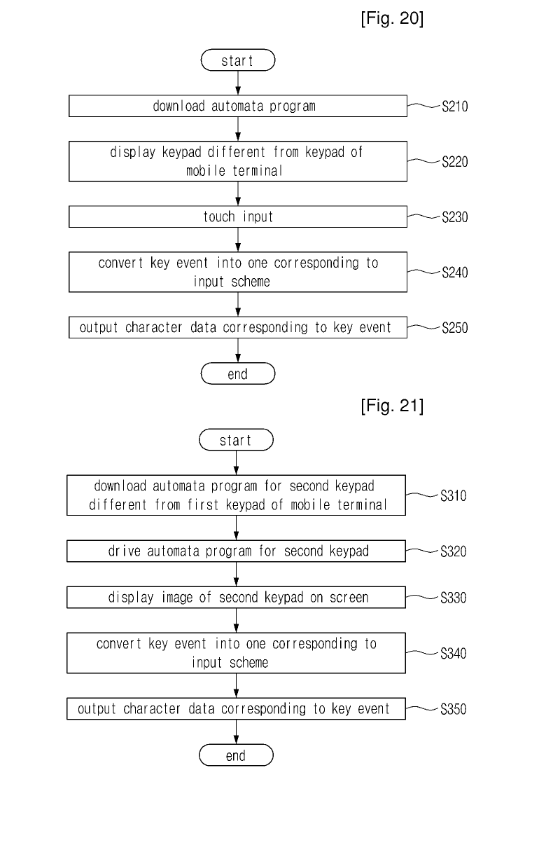

FIG. 20 illustrates a method of using a mobile terminal supporting various types of character input schemes according to a second embodiment of the present invention.

In this embodiment, a description will be given of how to input characters, numerals, symbols, etc. by using a second keypad different from a first keypad provided in the mobile terminal when the first keypad is a touch panel.

First, the mobile terminal downloads an automata program offline or online and stores it for displaying a second keypad different from a first keypad manufactured by the mobile terminal s manufacturer. Subsequently, if a user of the mobile terminal performs settings for using the second keypad, the mobile terminal displays the second keypad (S210 and S220).

If the user performs touch input by using the second keypad, a key event generated by the touch input is converted in such a manner as to coincide with an input scheme corresponding to the second keypad (S230 and S240).

With regard to this, the key events are stored in a queue format, and then are read out and converted one by one. Character data corresponding to the key event is audibly or visually output through the screen or speaker of the mobile terminal (S250).

FIG. 21 illustrates another method of using a mobile terminal supporting various character input schemes according to the second embodiment of the present invention.

In this embodiment, a description will be given of how to input characters, numerals, symbols, etc. by using a second keypad different from a first keypad provided in the mobile terminal when the first keypad is a key button type keypad rather than a touch panel.

An automata program for driving a second keypad that has a different input system from that of a first keypad manufactured by the manufacturer of the mobile terminal is installed in the mobile terminal (S310). The automata program may be stored in the memory at the time of manufacturing the mobile terminal or may be downloaded through a wired/wireless network at the request of a user.

When the user wants to input characters, numerals, etc. by using the second keypad different from the first keypad implemented in the mobile terminal, an image of the second keypad is displayed on the screen of the mobile terminal by driving the automata program of the second keypad through a menu item of the mobile terminal (S320 and S330).

If the user selects a key button corresponding to the second keypad in the first keypad of the mobile terminal, a key event generated in the first keypad is converted in such a manner as to coincide with an input scheme corresponding to the second keypad (S340). With regard to this, the key events are stored in a queue format, and then are read out and converted one by one.

Character data corresponding to the key event is audibly or visually output through the screen or speaker of the mobile terminal, but porting is performed before the output of the character data so as to coincide with features according to other manufacturers of the mobile terminal (S350).

### Embodiment 3

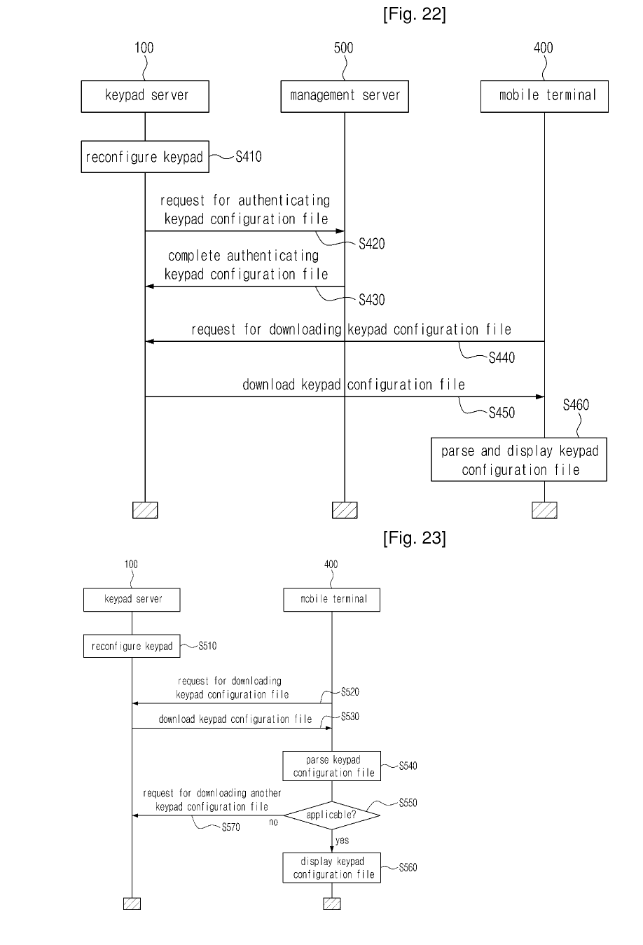

FIG. 22 illustrates a method of implementing various types of touch panels in a mobile terminal according to a third embodiment of the present invention.

The keypad server 100 creates a keypad configuration file by newly assigning a shortcut button of a touch panel to be implemented in the mobile terminal, deleting the existing shortcut button, changing the image of a shortcut button, or changing the position in which a shortcut button is displayed. Further, the keypad server 100 creates a keypad configuration file by changing the shape of each key button constituting the touch panel or reconfiguring the position of the key button (S410).

The keypad configuration file created in step S410 is an independent file, and stored in the keypad server 100. In order to check if the keypad configuration file is suitable for the specifications of the mobile terminal 400, the keypad server 100 transmits a request for authenticating the keypad configuration file to the management server 500 (S420).

Upon receiving the authentication request from the keypad server 100, the management server 500 determines if the keypad configuration file created in the keypad server 100 is suitable for the device specifications of the mobile terminal, and transmits an authentication completion message to the keypad server 100 if the keypad configuration file is suitable for the device specifications of the mobile terminal (S430).

In one application example, the management server 500 provides the keypad server 100 with specification information of a mobile terminal 400 to which the keypad configuration file is applicable, and the keypad server stores the keypad configuration file and the specification information of the mobile terminal 400 corresponding thereto.

When a user of the mobile terminal 400 requests the keypad server 100 to download the keypad configuration file, the keypad server checks the specifications of the mobile terminal 400 and displays a list of keypad configuration files suitable for the mobile terminal s specifications so as to enable the user to select a keypad configuration file from the list (S440).

If the user selects a keypad configuration file from the list, the keypads server 100 transmits the selected keypad configuration file to the mobile terminal 400 (S450).

Then, the mobile terminal 400 divides the keypad configuration file into a markup language, which is defined as an event prescribing the function of each key button of the touch panel, and a resource, and stores and manages respective data thereof. Further, the mobile terminal 400 parses the markup language and the resource to thereby display the keypad configuration file on the screen of the touch panel (S460).

If a pressed signal is input through the touch panel of the mobile terminal, on which the keypad is displayed, the mobile terminal 400 recognizes the pressed signal as a key event, and thus performs a function assigned to the key button.

FIG. 23 illustrates another method of implementing various types of touch panels in a mobile terminal according to the third embodiment of the present invention.

A touch panel to be implemented in the mobile terminal is reconfigured in the same manner as in the aforementioned method according to the third embodiment, and is created into a keypad configuration file. The created keypad configuration file is stored as one file in the keypad server 100 (S510).

If the mobile terminal accesses the keypad server 100 through a communication network or a data cable, searches for a plurality of keypad configuration files stored in the keypad server 100, selects one of them, and then requests for downloading thereof, the selected keypad configuration file is downloaded from the keypad server 100 to the mobile terminal 400 (S520 and S530).

In this method according to the third embodiment, since the keypad configuration file created in the keypad server 100 does not go through an authentication procedure, the keypad configuration file requested by the mobile terminal 400 is downloaded in its entirety.

Upon the completion of downloading the keypad configuration file, the mobile terminal 400 parses the downloaded keypad configuration file to thereby determine if it is applicable. If the keypad configuration file is determined to be applicable, the mobile terminal displays the keypad configuration file on the touch panel screen of the mobile terminal, and performs a function for a key event input through the touch panel (S540, S550 and S560).

However, if the parsed keypad configuration file is determined in step S550 to be non-applicable, the mobile terminal 400 requests the keypad server 100 to download another keypad configuration file (S570).

### INDUSTRIAL APPLICABILITY

Although several preferred embodiments of the present invention have been described for illustrative purposes, those skilled in the art will appreciate that various modifications, additions and substitutions are possible, without departing from the scope and spirit of the invention as disclosed in the accompanying claims.

1. A system for configuring a keypad of a terminal, the system comprising;
a keypad server including keypad configuration files according to various applications to be implemented in the terminal, and providing the terminal with the keypad configuration files; and
the terminal receiving the keypad configuration files from the keypad server through a wired or wireless network, and including a keypad area on which keypad configurations according to the keypad configuration files are displayed.

2. The system as claimed in claim 1, wherein the keypad server includes contents adaptive to a keypad configuration according to each of the various keypad configuration files, and provides the contents to the terminal.

3. The system as claimed in claim 1, wherein the terminal comprises:
a file reception unit receiving and storing at least one keypad configuration file corresponding to an application of the terminal, which is provided by the keypad server;
a file selection unit selecting a specific keypad configuration file from among the keypad configuration files received from the keypad server; and
a file execution unit executing the keypad configuration file selected by the file selection unit so as to display a keypad configuration according to the keypad configuration file on a keypad area of the terminal.

4. The system as claimed in claim 1 or 3, wherein the terminal further comprises a keypad located in the keypad area of the terminal and displaying the keypad configuration according to execution of the keypad configuration file.

5. The system as claimed in claim 4, wherein the keypad comprises:
a display unit displaying the keypad configuration according to the keypad configuration file; and
a key button input recognition circuit sensing selection of a specific key button area of the keypad configuration displayed on the display unit and transferring a signal according to the selection of the specific key button area to an internal logic of the terminal.

6. The system as claimed in claim 5, wherein the keypad further comprises a shock-absorbing member transferring a pressure according to the selection of the specific key button area and preventing the display unit from being damaged by the pressure.

7. The system as claimed in claim 4, wherein the keypad comprises:
a display unit displaying the keypad configuration according to the keypad configuration file; and
a transparent touch sensor array located on a front surface of the display unit, recognizing a touch with a user's finger when a specific key button area of the keypad configuration is selected, and transferring an electrical signal according to the touch with the user's finger to an internal logic of the terminal.

8. A system for implementing various types of touch panels, the system comprising:
a keypad server creating a keypad configuration file, which is to be displayed in a touch panel of a mobile terminal, by reconfiguring at least one of a shortcut button, a key button shape and a key button layout; and
the mobile terminal using the keypad configuration file as the touch panel by downloading the keypad configuration file from the keypad server and parsing the downloaded keypad configuration file.

9. The system as claimed in claim 8, wherein the mobile terminal comprises:
a manager module dividing the keypad configuration file into a markup language and a resource and managing respective data thereof;
a renderer parsing the keypad configuration file and displaying the parsed package on a screen; and
a control module recognizing a pressed signal input through the touch panel as a key event signal.

10. The system as claimed in claim 8 or 9, wherein the keypad configuration file includes at least one of the shortcut button, the key button shape and the key button layout to be implemented in the touch panel of the mobile terminal.

11. The system as claimed in claim 10, further comprising a management server receiving and managing the keypad configuration file created in the keypad server, performing an authentication procedure for checking if the keypad configuration file is applicable to the mobile terminal, and then downloading the keypad configuration file to the mobile terminal at the request of the mobile terminal.

12. A keypad server including keypad configuration files according to various applications to be implemented in a terminal and contents adaptive to respective keypad configurations according to the keypad configuration files, and providing the terminal with the keypad configuration files and the contents through a wired or wireless network.

13. The keypad server as claimed in claim 12, which separately provides each keypad configuration file and the contents adaptive to the keypad configuration file to the terminal through the wired or wireless network at the request of the terminal.

14. The keypad server as claimed in claim 12, which simultaneously provides the keypad configuration file related to the contents when the contents are provided, at the request of the terminal, so that the contents and the keypad configuration file are simultaneously implemented in the terminal.

15. The keypad server as claimed in any one of claims 12 to 14, wherein the terminal comprises any one of all kinds of apparatuses with a keypad, including a cellular phone, an Internet phone, a PDA, a PC, a typewriter and a remote controller.

16. A mobile terminal supporting various character input schemes, the mobile terminal comprising:
a keypad implemented in such a manner as to display a second keypad different from a first keypad provided in the mobile terminal and enable touch input through the second keypad;
a conversion unit converting a key event generated in the keypad in such a manner as to coincide with an input scheme corresponding to the second keypad; and
an output unit outputting character data corresponding to the converted key event.

17. The mobile terminal as claimed in claim 16, wherein the conversion unit stores the key event, generated in the keypad, in a queue format, and then reads out and converts the key event one by one.

18. The mobile terminal as claimed in claim 16 or 17, further comprising a memory downloading and storing an automata program for displaying the second keypad.

19. The mobile terminal as claimed in claim 18, wherein the keypad and the output unit perform porting so as to coincide with features according to other manufacturers of the mobile terminal.

20. A mobile terminal having various types of touch panels, the mobile terminal comprising:
a manager module dividing a keypad configuration file to be implemented in a touch panel of the mobile terminal into a markup language and a resource, and managing respective data thereof;
a parser module parsing the keypad configuration file based on the markup language and the resource of the keypad configuration file;
a renderer displaying data for the finally parsed keypad configuration file on a screen; and
a control module recognizing a pressed signal input through the touch panel as a key event signal.

21. The mobile terminal as claimed in claim 20, wherein the markup language is defined as an event prescribing a function of each key button of the touch panel.

22. The mobile terminal as claimed in claim 20 or 21, wherein the keypad configuration file includes at least one of a shortcut button, a key button shape and a key button layout to be implemented in the touch panel of the mobile terminal.

23. A reconfigurable keypad as information input means for inputting desired information into a terminal through key button input, the reconfigurable keypad comprising:
a display unit displaying a keypad configuration having a given key button layout provided by the terminal; and
a key button input recognition circuit located on a front or rear surface of the display unit and recognizing a pressure transferred when a specific key button area of the keypad configuration displayed on the display unit is selected.

24. The reconfigurable keypad as claimed in claim 23, further comprising a shock-absorbing member located adjacent to the display unit and the key button input recognition circuit, transferring a pressure generated when the specific key button area is selected, and preventing the display unit from being damaged by the pressure.

25. The reconfigurable keypad as claimed in claim 23 or 24, wherein the display unit changes the keypad configuration according to an application of the terminal, and displays the changed keypad configuration.

26. The reconfigurable keypad as claimed in claim 23 or 24, wherein the display unit changes the keypad configuration according to a keypad layout specified by a user of the terminal, and displays the changed keypad configuration.

27. The reconfigurable keypad as claimed in claim 23 or 24, wherein the display unit comprises a transparent display device.

28. The reconfigurable keypad as claimed in claim 27, wherein the display unit comprises any one of an electronic paper and an LCD (Liquid Crystal Display).

29. The reconfigurable keypad as claimed in claim 23 or 24, wherein the key button input recognition circuit recognizes the pressure transferred when the specific key button area is selected on the display unit, and transfers a signal according to selection of the specific key button area to an internal logic of the terminal.

30. The reconfigurable keypad as claimed in claim 23 or 24, wherein the shock-absorbing member consists of a transparent material so that the keypad configuration displayed on the display unit is visible.

31. The reconfigurable keypad as claimed in claim 23 or 24, wherein the shock-absorbing member is formed with protrusions having a given shape, which are positioned corresponding to a key button layout area displayed on the display unit.

32. A reconfigurable keypad as information input means for inputting desired information into a terminal through key button input, the reconfigurable keypad comprising:
a display unit displaying a keypad configuration having a given key button layout provided by the terminal; and
a touch sensor array located on a front surface of the display unit, recognizing a touch of a user when a specific key button area of the keypad configuration displayed on the display unit is selected, and transferring an electrical signal according to the touch of the user to an internal logic of the terminal.

33. The reconfigurable keypad as claimed in claim 32, wherein the display unit changes the keypad configuration according to an application of the terminal, and displays the changed keypad configuration

34. The reconfigurable keypad as claimed in claim 32, wherein the display unit changes the keypad configuration according to a keypad layout specified by the user of the terminal, and displays the changed keypad configuration.

35. The reconfigurable keypad as claimed in any one of claims 32 to 34, wherein the display unit comprises any one of an electronic paper and an LCD (Liquid Crystal Display).

36. The reconfigurable keypad as claimed in claim 32, wherein the touch sensor array consists of a transparent or translucent material so that the key button layout displayed on the display unit is visible.

37. A method of configuring a keypad of a terminal, the method comprising the steps of:
a) receiving and storing at least one of various keypad configuration files, each of which corresponds to an application, from a keypad server to the terminal through a wired or wireless network;
b) selecting a specific keypad configuration file having a given keypad configuration from among the stored keypad configuration files by the terminal;
c) executing the selected keypad configuration file through the application by the terminal; and
d) displaying the keypad configuration according to the specific keypad configuration file on a keypad area of the terminal.

38. The method as claimed in claim 37, wherein step b) comprises the step of, when the terminal receives specific contents from the keypad server, selecting a keypad configuration file compatible with the specific contents.

39. The method as claimed in claim 38, wherein, when there is no keypad configuration file compatible with the received specific contents in the terminal, steps a) to d) are performed in order to apply a keypad configuration file compatible with the specific contents.

40. A method of configuring a keypad of a terminal, the method comprising the steps of:
a) selecting a specific keypad configuration file having a given keypad configuration from among keypad configuration files already stored by the terminal;
b) executing the selected keypad configuration file through an application by the terminal; and
c) displaying the keypad configuration according to the specific keypad configuration file on a keypad area of the terminal.

41. The method as claimed in claim 40, wherein at least one of various keypad configuration files, each of which corresponds to an application, are received from a keypad server through a wired or wireless network, and stored as the already stored keypad configuration files.

42. The method as claimed in claim 40 or 41, wherein step a) comprises the step of, when the terminal executes specific contents, automatically selecting a keypad configuration file compatible with the specific contents.

43. The method as claimed in claim 42, wherein, when there is no keypad configuration file compatible with the specific contents in the terminal, a keypad configuration file compatible with the specific contents is newly downloaded from the keypad server.

44. A method of inputting a character in a mobile terminal, the method comprising the steps of:
a) displaying a second keypad different from a first keypad provided in the mobile terminal;
b) performing touch input by using the second keypad;
c) converting a key event generated by the touch input in such a manner as to coincide with an input scheme corresponding to the second keypad; and
d) outputting character data corresponding to the converted key event.

45. The method as claimed in claim 44, further comprising the step of downloading and storing an automata program for displaying the second keypad.

46. The method as claimed in claim 44 or 45, wherein step d) comprises the step of performing porting so as to coincide with features according to other manufacturers of the mobile terminal, and then outputting the character data.

47. The method as claimed in claim 46, wherein step c) comprises the step of storing the key event in a queue format, and then reading out and converting the key events one by one.

48. A method of inputting a character in a mobile terminal, the method comprising the steps of:
□) installing an automata program for driving a second keypad having a different input system from that of a first keypad provided in the mobile terminal;
□) driving the automata program by using a menu item of the mobile terminal to thereby display an image of the second keypad in the mobile terminal;
□) if a key button corresponding to the second keypad is selected in the first keypad, converting a key event generated in the first keypad in such a manner as to coincide with an input scheme corresponding to the second keypad; and
□) outputting character data corresponding to the converted key event.

49. The method as claimed in claim 48, wherein step □) comprises the step of performing porting so as to coincide with features according to other manufacturers of the mobile terminal, and then outputting the character data.

50. The method as claimed in claim 48 or 49, wherein step □) comprises the step of storing the key event in a queue format, and then reading out and converting the key events one by one.

51. A method of implementing various types of touch panels in a mobile terminal, the method comprising the steps of:
a) creating a keypad configuration file by reconfiguring at least one of a shortcut button, a key button shape and a key button layout to be implemented in a touch panel of the mobile terminal;
b) uploading the keypad configuration file and performing authentication for applicability of the keypad configuration file;
c) upon completing the authentication of the keypad configuration file, downloading the keypad configuration file to the mobile terminal; and
d) displaying a keypad on the touch panel by using the keypad configuration file in the mobile terminal.

52. The method as claimed in claim 51, wherein step c) comprises the step of, if one of the authenticated keypad configuration files is selected, automatically downloading the selected keypad configuration file to the mobile terminal.

53. The method as claimed in claim 51 or 52, wherein step c) comprises the steps of:
c-1) dividing the keypad configuration file into a markup language, which is defined as an event prescribing a function of each button of the touch panel, and a resource, and managing respective data thereof;
c-2) parsing the markup language and the resource to thereby display a keypad on a screen of the touch panel; and
c-3) recognizing a pressed signal input through the touch panel as a key event signal.

54. The method as claimed in claim 53, wherein the uploading and the downloading are performed through a wired or wireless network.

55. A method of implementing various types of touch panels in a mobile terminal, the method comprising the steps of:
□) creating a keypad configuration file to be implemented in a touch panel of the mobile terminal as a package; and
□) downloading the keypad configuration file to the mobile terminal.

56. The method as claimed in claim 55, further comprising the step of:
□) parsing the keypad configuration file to thereby display the parsed keypad configuration file on a screen in the mobile terminal.

57. The method as claimed in claim 55 or 56, wherein the keypad configuration file is downloaded to the mobile terminal through a data cable.

58. The method as claimed in claim 57, wherein the keypad configuration file includes at least one of a shortcut button, a key button shape and a key button layout.
